(19) United States
(12) Patent Application Publication
(10) Pub. No.: US 2022/0264478 A1
(43) Pub. Date: Aug. 18, 2022

(54) METHODS FOR COMMUNICATION, TERMINAL DEVICES, AND COMPUTER READABLE MEDIUM

(71) Applicant: NEC CORPORATION, Tokyo (JP)

(72) Inventors: Zhaobang MIAO, Beijing (CN); Gang WANG, Building (CN)

(73) Assignee: NEC CORPORATION, Tokyo (JP)

(21) Appl. No.: 17/626,900

(22) PCT Filed: Jul. 23, 2019
(86) PCT No.: PCT/CN2019/097300

§ 371 Date: Jan. 13, 2022

(51) Int. Cl. H04W 52/32; H04L 5/00

(52) U.S. Cl. CPC H04W 52/325; H04W 92/18; H04L 5/0005; H04L 5/0051

(57) ABSTRACT

Embodiments of the present disclosure provide a solution for sidelink power control. In a method for communication, a first terminal device generates a measurement report by measuring a reference signal from a second terminal device via a sidelink channel. The first terminal device determines, based on a report criterion, whether to transmit the measurement report to the second terminal device. In response to determining that the measurement report is to be transmitted, the first terminal device transmits the measurement report to the second terminal device, such that the second terminal device determines a path loss of the sidelink channel based on the measurement report. With the embodiments of the present disclosure, more effective and efficient measurement reports can be obtained and a path loss in a sidelink channel can be determined more accurately for transmission power control in a sidelink communication.

### FIELD

Embodiments of the present disclosure generally relate to the field of communication, and in particular, to a solution for sidelink power control.

### BACKGROUND

The latest developments of the 3GPP standards are referred to as Long Term Evolution (LTE) of Evolved Packet Core (EPC) network and Evolved Universal Mobile Telecommunications System (UMTS) Terrestrial Radio Access Network (E-UTRAN), also commonly termed as ‘4G.’ In addition, the term ‘5G New Radio (NR)’ refers to an evolving communication technology that is expected to support a variety of applications and services. The 5G NR is part of a continuous mobile broadband evolution promulgated by the Third Generation Partnership Project (3GPP) to meet new requirements associated with latency, reliability, security, scalability (for example, with Internet of Things), and other requirements. Some aspects of the 5G NR may be based on the 4G Long Term Evolution (LTE) standards.

In recent 3GPP meetings, the following has been agreed. For unicast receiving (RX) user equipment (UEs), sidelink (SL)-reference signal received power (RSRP) is reported to the transmitting (TX) UE. For sidelink open-loop power control for unicast for the TX UE, the TX UE derives an estimation of a path loss. For the SL open-loop power control, a UE can be configured to use a downlink (DL) path loss (between the TX UE and a gNB) only, a SL path loss (between the TX UE and the RX UE) only, or both the DL path loss and the SL path loss. However, various operation details and procedures of both the RX UE and the TX UE in relation to sidelink power control are still unclear and need to be clarified.

### SUMMARY

In general, example embodiments of the present disclosure provide a solution for sidelink power control.

In a first aspect, there is provided a method for communication. The method comprises generating, at a first terminal device, a measurement report by measuring a reference signal from a second terminal device via a sidelink channel. The method also comprises determining, based on a report criterion, whether to transmit the measurement report to the second terminal device. The method further comprises in response to determining that the measurement report is to be transmitted, transmitting the measurement report to the second terminal device, such that the second terminal device determines a path loss of the sidelink channel based on the measurement report.

In a second aspect, there is provided a method for communication. The method comprises transmitting, at a second terminal device and in a time window, a plurality of reference signals to a first terminal device via a sidelink channel. The method also comprises determining average received power of the plurality of reference signals measured by the first terminal device in the time window. The method further comprises determining a path loss of the sidelink channel based on a difference between the average received power and average transmission power of the plurality of reference signals.

In a third aspect, there is provided a method for communication. The method comprises receiving, at a second terminal device and from a first terminal device, a measurement report for reporting received power of a reference signal measured by the first terminal device. The reference signal is transmitted from the second terminal device to the first terminal device via a sidelink channel. The method also comprises determining transmission power of the reference signal. The method further comprises determining a path loss of the sidelink channel based on the received power and the transmission power.

In a fourth aspect, there is provided a method for communication. The method comprises transmitting, at a second terminal device and to a first terminal device, information for the first terminal device to perform layer 3 filtering on received power of a reference signal measured by the first terminal device. The reference signal is transmitted from the second terminal device to the first terminal device via a sidelink channel. The method also comprises receiving, from the first terminal device, a measurement report for reporting the filtered received power. The method further comprises determining a path loss of the sidelink channel based on the information and the filtered received power.

In a fifth aspect, there is provided a first terminal device. The first terminal device comprises a processor and a memory storing instructions. The memory and the instructions are configured, with the processor, to cause the first terminal device to perform the method according to the first aspect.

In a sixth aspect, there is provided a second terminal device. The second terminal device comprises a processor and a memory storing instructions. The memory and the instructions are configured, with the processor, to cause the second terminal device to perform the method according to the second aspect, the third aspect, or the fourth aspect.

In a seventh aspect, there is provided a computer readable medium having instructions stored thereon. The instructions, when executed on at least one processor of a device, cause the device to perform the method according to the first aspect, the second aspect, the third aspect, or the fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which some embodiments of the present disclosure can be implemented;

FIG. 2 shows an example communication process between a first terminal device and a second terminal device in accordance with some embodiments of the present disclosure;

FIG. 3 shows another example communication process between a first terminal device and a second terminal device in accordance with some embodiments of the present disclosure;

FIG. 4A shows an example scenario in which a first terminal device transmits individual measurement reports for a plurality of reference signals to a second terminal device in accordance with some embodiments of the present disclosure;

FIG. 4B shows an example scenario in which a first terminal device transmits a single measurement report for reporting average received power of a plurality of reference signals to a second terminal device in accordance with some embodiments of the present disclosure;

FIG. 5A shows another example communication process between a first terminal device and a second terminal device in accordance with some embodiments of the present disclosure;

FIG. 5B shows another example communication process between a first terminal device and a second terminal device in accordance with some embodiments of the present disclosure;

FIG. 6 shows another example communication process between a first terminal device and a second terminal device in accordance with some embodiments of the present disclosure;

FIG. 7 shows an example distribution of resources for transmitting reference signals and associated measurement reports in which a measurement report is transmitted in a PSFCH associated with the PSSCH related to the reference signal in accordance with some embodiments of the present disclosure;

FIG. 8 shows another example distribution of resources for transmitting reference signals and associated measurement reports in which two ordered sets of time-frequency resources are used for transmitting the reference signals and the associated measurement reports in accordance with some embodiments of the present disclosure;

FIG. 9 shows another example distribution of resources for transmitting reference signals and associated measurement reports in which a measurement report includes time information of the related reference signal in accordance with some embodiments of the present disclosure;

FIG. 10 shows another example communication process between a first terminal device and a second terminal device in accordance with some embodiments of the present disclosure;

FIG. 11 shows a flowchart of an example method in accordance with some embodiments of the present disclosure;

FIG. 12 shows a flowchart of another example method in accordance with some embodiments of the present disclosure;

FIG. 13 shows a flowchart of another example method in accordance with some embodiments of the present disclosure;

FIG. 14 shows a flowchart of another example method in accordance with some embodiments of the present disclosure; and

FIG. 15 is a simplified block diagram of a device that is suitable for implementing some embodiments of the present disclosure.

Throughout the drawings, the same or similar reference numerals represent the same or similar elements.

### DETAILED DESCRIPTION OF EMBODIMENTS

Principles of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can perform communication. Examples of a network device include, but not limited to, a Node B (NodeB or NB), an Evolved NodeB (eNodeB or eNB), a next generation NodeB (gNB), an infrastructure device for a V2X communication, a Transmission/Reception Point (TRP), a Remote Radio Unit (RRU), a radio head (RH), a remote radio head (RRH), a low power node such as a femto node, a pico node, and the like.

As used herein, the term “terminal device” refers to any device having wireless or wired communication capabilities. Examples of the terminal device include, but not limited to, user equipment (UE), vehicle-mounted terminal devices, devices of pedestrians, roadside units, personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like. For the purpose of discussion, in the following, some embodiments will be described with reference to UEs as examples of terminal devices and the terms “terminal device” and “user equipment” (UE) may be used interchangeably in the context of the present disclosure.

In one embodiment, a terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is an eNB and the second RAT device is a gNB. Information related to different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

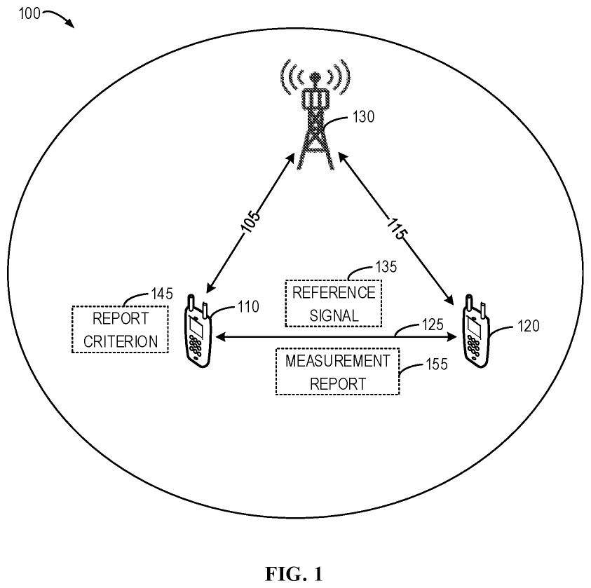

FIG. 1 is a schematic diagram of a communication environment 100 in which some embodiments of the present disclosure can be implemented. As shown in FIG. 1, a first terminal device 110 and a second terminal device 120 are in coverage of a network device 130. In other words, the network device 130 may serve the first terminal device 110 and the second terminal device 120, and can provide wireless connections for them. In particular, the first terminal device 110 may communicate with the network device 130 via a communication channel 105, and the second terminal device 120 may communicate with the network device 130 via a communication channel 115. For transmissions from the network device 130 to the first terminal device 110 or the second terminal device 120, the communication channel 105 or 115 may be referred to as a downlink channel, whereas for transmissions from the first terminal device 110 or the second terminal device 120 to the network device 130, the communication channel 105 or 115 may alternatively be referred to as an uplink channel.

Additionally, the first terminal device 110 may communicate with the second terminal device 120 via a device-to-device (D2D) channel 125, which may also be referred to as a sidelink channel 125. In some cases, the network device 130 may be absent in the communication environment 100. For example, the first terminal device 110 and the second terminal device 120 are out of the coverage of the network device 130. In such cases, only sidelink communications exist between the first terminal device 110 and the second terminal device 120 as well as possibly other terminal devices not shown in FIG. 1.

In some embodiments, during a sidelink communication between the first terminal device 110 and the second terminal device 120 via the sidelink channel 125, the second terminal device 120 may transmit a reference signal 135 to the first terminal device 110 using a first set of transmission resources. As used herein, a reference signal may refer to a signal known to both the transmitting device and the receiving device, and may be used to perform channel estimation, channel sounding, or the like. In general, the reference signal as used herein may include any existing or future reference signal as defined in various standards or specifications, such as, 3GPP specifications. Upon receiving the reference signal 135, the first terminal device 110 can measure the reference signal 135 to obtain a measurement result of the reference signal 135, such as, the received power of the reference signal 135, the received quality of the reference signal 135, or the like.

Then, the first terminal device 110 may generate a measurement report 155 based on the measurement result of the reference signal 135. For example, the measurement report 155 may include information indicating the received power of the reference signal 135 measured by the first terminal device 110. Afterwards, the first terminal device 110 may transmit the measurement report 155 to the second terminal device 120 using a second set of transmission resources. Based on the measurement report 155, the second terminal device 120 can obtain channel information of the sidelink channel 125. For example, the second terminal device 120 may determine a path loss of the sidelink channel 125 based on the transmission power of the reference signal 135 and the received power of the reference signal 135 reported by the first terminal device 110.

As used herein, the term “resource,” “transmission resource,” or “sidelink resource” may refer to any resource for performing a communication, for example, a sidelink communication between communication devices, such as a resource in time domain (for example, a time slot), a resource in frequency domain (for example, a sub-channel), a resource in space domain, a resource in code domain, or any other resource enabling a communication, and the like. In the following, a resource in both frequency domain and time domain will be used as an example of a sidelink resource for describing some embodiments of the present disclosure. However, it is noted that embodiments of the present disclosure are equally applicable to other resources in other domains.

As defined in the 3GPP specifications, a measurement result obtained by the first terminal device 110 through measuring the reference signal 135 may be termed as a measurement result of layer 1, namely, the physical layer. Before reporting the measurement result to the second terminal device 120, the first terminal device 110 may perform layer 3 filtering on the measurement result of layer 1 to obtain the filtered measurement result for reporting to the second terminal device 120. Alternatively, if the first terminal device 110 reports the measurement result of layer 1 to the second terminal device 120, before using for the determining the path loss, the second terminal device 120 may perform layer 3 filtering on the measurement result of layer 1 to obtain the filtered measurement result for determining the path loss. For example, the layer 3 filtering can be performed according to the following formula (1):

Fₙ=(1−a)·Fₙ₋₁+a·Mₙ (1)

where Mₙ is the latest received measurement result from the physical layer; Fₙ is the updated filtered measurement result, that is used for evaluation of reporting criteria or for measurement reporting; Fₙ₋₁ is the old filtered measurement result, where F₀ is set to MI when the first measurement result from the physical layer is received; and a=½^{(k/4)}, where k is the filterCoefficient for the corresponding measurement quantity received by the quantityConfig as defined in the 3GPP specifications.

Although the first terminal device 110, the second terminal device 120, and the network device 130 are described in the communication environment 100 of FIG. 1, embodiments of the present disclosure may be equally applicable to any other suitable communication devices in communication with one another. That is, embodiments of the present disclosure are not limited to the example scenario of FIG. 1. In this regard, it is noted that although the first and second terminal devices 110 and 120 are schematically depicted as mobile phones in FIG. 1, it is understood that this depiction is only for example without suggesting any limitation. In other embodiments, the first and second terminal devices 110 and 120 may be any other wireless communication devices, for example, vehicle-mounted terminal devices.

In case the first and second terminal devices 110 and 120 are vehicle-mounted terminal devices, the communications relate to the first and second terminal devices 110 and 120 may be referred to as V2X communications. More generally, although not shown in FIG. 1, a V2X communication related to the first terminal device 110 or the second terminal device 120 may comprise a communication between the first terminal device 110 or the second terminal device 120 and any other communication device, including but not limited to, an infrastructure device, another vehicle-mounted terminal device, a device of a pedestrian, a roadside unit, or the like. Furthermore, although not shown, all the communication links as shown in FIG. 1 may be via one or more relays.

It is to be understood that the number of the terminal devices and the number of the network devices as shown in FIG. 1 are only for the purpose of illustration without suggesting any limitations. The communication environment 100 may include any suitable number of terminal devices, any suitable number of network devices, and any suitable number of other communication devices adapted for implementing embodiments of the present disclosure. In addition, it would be appreciated that there may be various wireless communications as well as wireline communications (if needed) among all the communication devices.

The communications in the communication environment 100 may conform to any suitable standards including, but not limited to, Global System for Mobile Communications (GSM), Extended Coverage Global System for Mobile Internet of Things (EC-GSM-IoT), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

As mentioned above, in conventional solutions, various operation details and procedures of both a RX UE and a TX UE in relation to sidelink power control are still unclear and thus need to be clarified. Particularly, in traditional LTE sidelink communications, the SL-RSRP is used in the cases like a synchronization source search and resource sensing. Additionally, in the traditional LTE/NR uplink power control, the RSRP is used for performing an estimation of a path loss. No RSRP transmitting/reporting to other UEs is defined in these conventional solutions.

By contrast, in NR sidelink communications, for unicast RX UEs (also applicable to groupcast or broadcast RX UEs), it is specified that the SL-RSRP may be reported to a TX UE for determining a sidelink path loss. However, there are some issues with reporting a measurement report of a reference signal in sidelink communications. For example, in the traditional solutions, occasions for measuring and reporting the RSRP at a RX UE are not defined and some occasions may be unnecessary.

Moreover, in NR sidelink communications, the transmission power of the reference signal (which can be represented by energy per resource element, EPRE) from a TX UE may vary slot-by-slot due to transmission power control. Also, the measurement reports transmitted by the RX UE may not have a same order in time domain as the order in which the reference signals are transmitted, and the RX UE may miss some of the reference signals. Due to these reasons, the TX UE cannot know the transmit power of the reference signal associated with a received measurement report.

Furthermore, it is indefinite when and where the SL-RSRP needs to be transmitted to the TX UE. For example, it is unclear that the RX UE uses which channel and which transmission resources to transmit a measurement report. It is also unclear whether the RX UE transmits a measurement report once it is generated or based on a periodicity.

In summary, in the traditional solutions, a measurement of a reference signal and a measurement report may be unnecessary in some cases. Also, when a TX UE receives a measurement report from a RX UE, the transmission power (for example, the EPRE) of the associated reference signal is unclear.

In order to solve the above technical problems and potentially other technical problems in conventional solutions, embodiments of the present disclosure provide a solution for sidelink power control. In some embodiments, behaviors of measurements of reference signals and measurement reports at the TX UE and the RX UE are specified. In some embodiments, the layer 3 filtering can be performed at the TX UE, and average transmission power and average received power within a time window are used to determine a path loss. For example, the RX UE reports individual measurement results, and the average transmission power and the average received power are calculated at the TX UE. Alternatively, the RX UE reports the average received power, and the average transmission power is calculated at the TX UE.

In some embodiments, the layer 3 filtering can be performed at the TX UE, the reported measurement result has one-to-one mapping with the reference signal. For example, the mapping between the measurement report and the reference signal may be indicated in an implicit way by distinguishing through transmission resources. Alternatively, the mapping may be indicated in an explicit way by indicating the transmission time point of the reference signal. In some embodiments, the layer 3 filtering can be performed at the RX UE. The TX UE indicates transmission power information (e.g. reference transmission power and/or actually used transmission power) to the RX UE and the RX UE uses a normalized received power to perform the L3 filtering.

With the embodiments of the present disclosure, more effective and efficient measurement reports can be obtained and a path loss in a sidelink channel can be determined more accurately for transmission power control in a sidelink communication. Principles and implementations of the present disclosure will be described in detail below with reference to the figures.

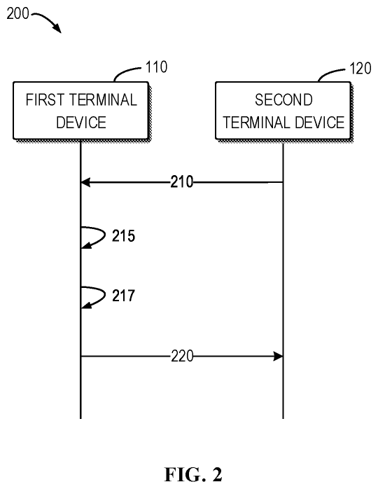

FIG. 2 shows an example communication process 200 between the first terminal device 110 and the second terminal device 120 in accordance with some embodiments of the present disclosure. For the purpose of discussion, the communication process 200 will be described with reference to FIG. 1. However, it would be appreciated that the communication process 200 may be equally applicable to other communication scenarios where two terminal devices communicate with each other via a sidelink channel.

As shown in FIG. 2, the second terminal device 120 transmits 210 the reference signal 135 to the first terminal device 110 via the sidelink channel 125. As mentioned, the reference signal 135 may be used to perform channel estimation, channel sounding, or the like. For this purpose, the first terminal device 110 measures 210 the reference signal 135 and then generates 215 the measurement report 155 based on a measurement result of the reference signal 135. In other words, the first terminal device 110 generates 215 the measurement report 155 by measuring 210 the reference signal 135.

In some embodiments, in order to avoid unnecessary measurements of reference signals, the first terminal device 110 can use a measurement criterion to determine whether to measure 210 the reference signal 135 and generate 215 the measurement report 155. In other words, the first terminal device 110 can determine, based on the measurement criterion, whether to measure 210 the reference signal 135 and generate 215 the measurement report 155. If it is determined that the reference signal 135 is to be measured, the terminal device 110 can measure 210 the reference signal 135 and then generate the measurement report 155. In this way, the first terminal device 110 does not always measure a reference signal transmitted from the second terminal device 120. Instead, the first terminal device 110 can measure the reference signal 135 if the measurement of the reference signal 135 is necessary, thereby improving the efficiency of the measurement report 155 and saving the processing resources and other resources at the first terminal device 110 for performing the measurement.

In general, the measurement criterion may be any suitable criterion that enables the first terminal device 110 to avoid an unnecessary measurement of a reference signal. In some embodiments, the measurement criterion may be that the second terminal device 120 is to use the path loss of the sidelink channel 125 to perform transmission power control. For example, if the second terminal device 120 is configured to only use the path loss of the sidelink channel 125 to perform the transmission power control, or use both a path loss of the downlink channel 115 and the path loss of the sidelink channel 125 to perform the transmission power control, the first terminal device 110 may be enabled to measure the reference signal 135.

Otherwise, if the second terminal device 120 is configured to only use the path loss of the downlink channel 115 to perform the transmission power control, meaning that the measurement report 155 of the reference signal 135 in sidelink channel 125 is useless for the second terminal device 120, then the first terminal device 110 may be disabled to measure the reference signal 135. In some embodiments, an indication for indicating whether the second terminal device 120 is to use the path loss of the sidelink channel 125 may be transmitted to the first terminal device 110 from the second terminal device 120 or the network device 130, for example, via higher layer signaling.

Alternatively or additionally, the measurement criterion may be that an estimated path loss (or a radio distance) of the sidelink channel 125 is below a configurable threshold (also referred to as a first threshold). As used herein, the term “radio distance” between two devices may refer to a distance in the sense of wireless communications between the two devices. For example, if there is an obstruction in a wireless communication path between the two devices, which may impact the wireless communications, then the radio distance between the two devices can be longer than the actual geographic distance between them. Therefore, the estimated path loss of the sidelink channel 125 can be obtained based on the radio distance between the first terminal device 110 and the second terminal device 120. In this event, if the estimated path loss is below the first threshold, the first terminal device 110 may determine to measure the reference signal 135. Otherwise, if the estimated path loss is above the first threshold, the first terminal device 110 can determine to not measure the reference signal 135.

The reason is that according to the agreements in recent 3GPP meetings, in case the SL open-loop power control is configured to use both the DL path loss and the SL path loss, the minimum of the power values given by the open-loop power control based on the DL path loss and the open-loop power control based on the SL path loss is taken. Therefore, if the radio distance between the first terminal device 110 and the second terminal device 120 is large, which may result in a great power value through the open-loop power control, the second terminal device 120 may not use the path loss of the sidelink channel 125 to perform the transmission power control. In this event, the measurement of the reference signal 135 may be unnecessary.

In some embodiments, an indication for indicating whether the estimated path loss of the sidelink channel 125 is below the first threshold can be transmitted to the first terminal device 110 from the network device 130, for example, via RRC signaling, or from the second terminal device 120, for example, via a field in sidelink control information (SCI). In some other embodiments, the first terminal device 110 may be aware of the radio distance between itself and the second terminal device 120, and thus the first terminal device 110 can make the decision by itself as to whether the estimated path loss is below the first threshold.

Alternatively or additionally, the measurement criterion may be that a path loss (or a radio distance) of the communication channel 115 between the second terminal device 120 and the network device 130 exceeds a configurable threshold (also referred to as a second threshold). In other words, if the path loss of the communication channel 115 exceeds the second threshold, the first terminal device 110 may determine to measure the reference signal 135. Otherwise, if the path loss of the communication channel 115 is below the second threshold, the first terminal device 110 can determine to not measure the reference signal 135.

This is also because the minimum of the power values given by the open-loop power control based on the DL path loss and the open-loop power control based on the SL path loss is taken, in case both of the two are used to perform the transmission power control. Therefore, if the path loss of the communication channel 115 (such as, the downlink channel 115) is small, which may result in a small power value through the open-loop power control, the second terminal device 120 may probably use the path loss of the communication channel 115 rather than using the path loss of the sidelink channel 125 to perform transmission power control. In this event, the measurement of the reference signal 135 may be unnecessary. In some embodiments, an indication for indicating whether the path loss of the communication channel 115 exceeds the second threshold may be transmitted to the first terminal device 110 from the network device 130, for example, via RRC signaling, or from the second terminal device 120, for example, via a field in a SCI.

Alternatively or additionally, the measurement criterion may be that a priority of a sidelink data transmission to be performed via the sidelink channel 125 exceeds a configurable threshold (also referred to as a third threshold). In other words, if the priority of the sidelink data transmission exceeds the third threshold, the first terminal device 110 may determine to measure the reference signal 135. Otherwise, if the priority of the sidelink data transmission is below the third threshold, the first terminal device 110 can determine to not measure the reference signal 135.

The reason is that if the priority of the sidelink data transmission is low, which means that the sidelink data transmission is unimportant, then the first terminal device 110 may not to measure the reference signal 135 and thus not transmit the measurement report 155 to the second terminal device 120, thereby avoiding adversely affecting the communications between the first terminal device 110 or the second terminal device 120 and the network device 130. In some embodiments, an indication for indicating whether the priority of the sidelink data transmission exceeds the third threshold may be transmitted to the first terminal device 110 from the network device 130, for example, via RRC signaling, or from the second terminal device 120, for example, via a field in a SCI.

In some embodiments, the first terminal device 110 may have a plurality of antenna ports that can be used to receive the reference signal 135. For example, these antenna ports can be numbered as antenna port 0, antenna port 1, antenna port 2, and so on. As specified in the 3GPP specifications, an antenna port is defined such that the channel over which a symbol on the antenna port is conveyed can be inferred from the channel over which another symbol on the same antenna port is conveyed. Accordingly, in measuring the reference signal 135, the first terminal device 110 may measure the received power of the reference signal 135 received via one (for example, the antenna port 0) of the plurality of antenna ports of the first terminal device 110. In this way, the measurement procedure of the reference signal 135 can be simplified and the burden at the first terminal device 110 for measuring a reference signal may be reduced. Alternatively, the first terminal device 110 may measure average received power of the reference signal 135 received via the plurality of antenna ports of the first terminal device 110. As such, the measurement result of the reference signal 135 can be more accurate.

In some embodiment, reference signals transmitted form the second terminal device 120 to the first terminal device 110 including the reference signal 135 may have various types. For example, these types may include but not limited to the type of PSSCH demodulation (DM)-reference signal (RS), the type of sidelink channel state information (CSI)-RS, and the like. In general, the first terminal device 110 can measure a reference signal of any type. However, in some embodiments, the first terminal device 110 may be configured to measure a reference signal of a predefined type, such as a DM-RS or a CSI-RS. As such, the first terminal device 110 can focus on only one type of reference signals when performing the measurements. For example, such configuration of the first terminal device 110 can be performed through a higher layer configuration or a SCI indication.

In some other embodiments, there may be only one type of reference signals while the first terminal device 110 performs measurements of reference signals from the second terminal device 120, for example, there may be only DM-RSs or CSI-RSs. In this event, the first terminal device 110 can measure the reference signals of the type existing during the first terminal device 110 performs the measurements. Alternatively, if reference signals having different types are transmitted by the second terminal device 120 while the first terminal device 110 performs the measurements, the first terminal device 110 may measure the reference signals with different types. For example, if the DM-RSs and the CSI-RSs both exist during the first terminal device 110 performs the measurements, the first terminal device 110 can measure both the DM-RSs and the CSI-RSs. In this way, the number of reference signals available for the first terminal device 110 to perform measurements can be maximized.

In some embodiments, the first terminal device 110 can measure the reference signal 135 on various occasions. As an example, if the reference signal 135 is associated with a sidelink data transmission via the sidelink channel 125, the first terminal device 110 may measure the received power of the reference signal. In this example, the reference signal 135 may be a DM-RS, and the first terminal device 110 may measure the received power of a reference signal associated with every PSSCH transmission. In this way, the first terminal device 110 may obtain a maximum amount of measurement occasions for measuring the DM-RSs, and can obtain a more accurate measurement result.

Alternatively or additionally, if the first terminal device 110 receives an indication from the second terminal device 120 indicating that the received power of the reference signal 135 is to be measured, the first terminal device 110 may measure the received power of the reference signal 135. For example, the indication can be transmitted via a SCI. As such, the reference signals for measuring the received power and for determining the path loss can be selected by the second terminal device 120 as the transmitting device of the reference signals.

Alternatively or additionally, if the first terminal device 110 selects the reference signal 135 from a plurality of reference signals to measure the received power, the first terminal device 110 may measure the received power of the reference signal 135. For example, if the reference signals available for measuring are DM-RSs, the first terminal device 110 can decide by itself to measure some of the reference signals associated with selected PSSCH transmissions. In this manner, the first terminal device 110 may measure less reference signals, and thus can save processing resources and power for performing the measurements. As an option, the selection of the PSSCH transmissions may be based on a radio distance between the first terminal device 110 and the second terminal device 120, because if the radio distance is large, then the second terminal device 120 may probably not use the path loss of the sidelink channel 125 to perform the transmission power control, and thus the measurement of the reference signal 135 may be unnecessary.

Alternatively or additionally, if the first terminal device 110 measures channel state information (CSI) of the sidelink channel 125 based on the reference signal 135, the first terminal device 110 may measure the received power of the reference signal 135. For example, the reference signal 135 may be a CSI-RS in this event, and the measurement of the received power is synchronized with the CSI measurement. As such, different types of measurements can be performed based on a same reference signal concurrently, thereby taking full advantage of the CSI-RSs and measurement occasions.

Continuing with reference to FIG. 2, in order to avoid unnecessary measurement reports from the first terminal device 110 to the second terminal device 120, the first terminal device 110 determines 217, based on a report criterion 145, whether to transmit the measurement report 155 to the second terminal device 120. In other words, the first terminal device 110 does not always transmit a measurement report to the second terminal device 120. Instead, the first terminal device 110 can transmit the measurement report 155 of the reference signal 135 if it is necessary to transmit the measurement report 155 to the second terminal device 120, thereby improving the effectiveness of the measurement report 155 for the second terminal device 120 and saving the processing resources and other resources at both the first terminal device 110 and the second terminal device 120 for transmitting or receiving unnecessary measurement reports.

In general, the report criterion 145 may be any suitable criterion that enables the first terminal device 110 to avoid reporting an unnecessary measurement report. In some embodiments, the report criterion 145 may be analogous to the measurement criterion as described above, which may be used by the first terminal device 110 to determine whether to measure the reference signal 135.

For example, the report criterion 145 may be that the second terminal device 120 is to use the path loss of the sidelink channel 125 to perform transmission power control. In other words, if the second terminal device 120 is configured to only use the path loss of the sidelink channel 125 to perform the transmission power control, or use both a path loss of the downlink channel 115 and the path loss of the sidelink channel 125 to perform the transmission power control, the first terminal device 110 may transmit the measurement report 155 to the second terminal device 120. Otherwise, if the second terminal device 120 is configured to only use the path loss of the downlink channel 115 to perform the transmission power control, meaning that the measurement report 155 of the reference signal 135 in sidelink channel 125 is useless for the second terminal device 120, then the first terminal device 110 may not transmit the measurement report 155 to the second terminal device 120.

Alternatively or additionally, the report criterion 145 may be that the estimated path loss (or the radio distance) of the sidelink channel 125 is below the first threshold. In this event, if the estimated path loss is below the first threshold, the first terminal device 110 may transmit the measurement report 155 to the second terminal device 120. Otherwise, if the estimated path loss is above the first threshold, the first terminal device 110 may not transmit the measurement report 155 to the second terminal device 120. As described, the reason is that if the radio distance between the first terminal device 110 and the second terminal device 120 is large, which may result in a great power value through the open-loop power control, the second terminal device 120 may not use the path loss of the sidelink channel 125 to perform the transmission power control. In this event, the measurement report 155 of the reference signal 135 may be unnecessary.

Alternatively or additionally, the report criterion 145 may be that the path loss (or the radio distance) of the communication channel 115 between the second terminal device 120 and the network device 130 exceeds the second threshold. In other words, if the path loss of the communication channel 115 exceeds the second threshold, the first terminal device 110 may transmit the measurement report 155 to the second terminal device 120. Otherwise, if the path loss of the communication channel 115 is below the second threshold, the first terminal device 110 may not transmit the measurement report 155 to the second terminal device 120. As described, the reason is that if the path loss of the communication channel 115 (such as, the downlink channel 115) is small, which may result in a small power value through the open-loop power control, the second terminal device 120 may probably use the path loss of the communication channel 115 rather than using the path loss of the sidelink channel 125 to perform transmission power control. In this event, the measurement report 155 of the reference signal 135 may be unnecessary.

Alternatively or additionally, the report criterion 145 may be that the priority of a sidelink data transmission to be performed via the sidelink channel 125 exceeds the third threshold. In other words, if the priority of the sidelink data transmission exceeds the third threshold, the first terminal device 110 may transmit the measurement report 155 to the second terminal device 120. Otherwise, if the priority of the sidelink data transmission is below the third threshold, the first terminal device 110 may not transmit the measurement report 155 to the second terminal device 120. As described, the reason is that if the priority of the sidelink data transmission is low, which means that the sidelink data transmission is unimportant, then the first terminal device 110 may not transmit the measurement report 155 to the second terminal device 120, thereby avoiding adversely affecting the communications between the first terminal device 110 or the second terminal device 120 and the network device 130.

It is possible that the first terminal device 120 uses both the measurement criterion and the report criterion 145 and that the two criteria are the same. In this event, the first terminal device 120 can determine whether the common criterion is satisfied for only once, instead of checking the common criterion twice. If the common criterion is satisfied, the first terminal device 120 can measure the reference signal 135 and then transmit the measurement report 155. Otherwise, if the common criterion is not satisfied, then the first terminal device 120 may not measure the reference signal 135 and not transmit the measurement report 155. In addition, although in the described embodiments, a common first threshold, a common second threshold, and a common third threshold are configured for the measurement criterion and the report criterion 145, in some other embodiments, two different thresholds can be configured for the two criteria, respectively.

Continuing with reference to FIG. 2, if the first terminal device 110 determines 217 that the measurement report 155 is to be transmitted, then the first terminal device 110 transmits 220 the measurement report 155 to the second terminal device 120, such that the second terminal device 120 determines the path loss of the sidelink channel 125 based on the measurement report 155. In general, the first terminal device 110 can use any available transmission resources to transmit 220 the measurement report 155. For example, the measurement report 155 may be transmitted in a predefined set of transmission resources for a PSSCH from the first terminal device 110 to the second terminal device 120. The predefined set of transmission resources may be known to both the first terminal device 110 and the second terminal device 120, and thus the second terminal device 120 can know whether a transmission resource is used to transmit a measurement report.

Alternatively or additionally, the measurement report 155 can be transmitted in a selected set of transmission resources for the PSSCH, and the selected set can be indicated in an indication transmitted from the first terminal device 110 to the second terminal device 120. In other words, the selected set of transmission resources can be selected by the first terminal device 110, which can inform the second terminal device 120 whether a transmission resource is used to transmit a measurement report. Alternatively or additionally, the measurement report 155 can be transmitted in a medium access control (MAC) control element (CE) transmitted from the first terminal device 110 to the second terminal device 120. For example, a field in the MAC CE can be used to indicate the RSRP value to be reported. Alternatively or additionally, the measurement report 155 can be transmitted in a set of transmission resources for a PSFCH from the first terminal device 110 to the second terminal device 120.

In some embodiments, in order to avoid frequent measurement reports, the first terminal device 110 can transmit the measurement report 155 if a difference between a value to be reported in the measurement report 155 and a previous value reported in a previous report exceeds a configurable threshold (also referred to as a fourth threshold). In other words, in case a change in the path loss of the sidelink channel 125 is great enough, the first terminal device 110 can transmit the measurement report 155 to the second terminal device 120. In this way, the processing resources and other resources at both the first terminal device 110 and the second terminal device 120 for transmitting or receiving measurement reports of reference signals can be saved.

In some other embodiments, the first terminal device 110 may transmit a plurality of measurement reports including the measurement report 155 periodically. As such, the path loss of the sidelink channel 125 can be determined by the second terminal device 120 periodically, and the accuracy of the determined path loss can be adjusted through the periodicity. In some embodiments, in order to report a received power value having a small absolute value, the first terminal device 110 may subtract a predefined value (such as, −140 dBm) from the value to be reported. In this way, the number of the information bits for reporting the received power of the reference signal 135 can be reduced.

In some embodiments, the first terminal device 110 as the receiving device of the reference signal 135 can also determine the path loss of the sidelink channel 125 and perform transmission power control based on the path loss. For example, this may be the case that the channel reciprocity of the sidelink channel 125 is assumed to be true. To this end, the first terminal device 110 may receive, from the second terminal device 120, information indicating the transmission power of the reference signal 135. Then, the first terminal device 110 may perform the transmission power control based on a difference between the transmission power of the reference signal 135 and the received power of the reference signal 135 measured by the first terminal device 110. In this manner, there is no need for the first terminal device 110 to transmit another reference signal to the second terminal device 120 to determine the path loss of the sidelink channel 125.

In some embodiments, before using the difference to perform the transmission power control, the first terminal device 110 may perform the layer 3 filtering on the difference. For example, the layer 3 filtering can be performed according to the formula (1) as specified in 3GPP specifications. In some embodiments, the transmission power control as performed by the first terminal device 110 can be used for transmitting the measurement report 155 or any other sidelink data to the second terminal device 120. In some embodiments, the transmission power control at the first terminal device 110 may be performed in the case that the first terminal device 110 is configured to use the path loss of the sidelink channel 125 to perform transmission power control.

As mentioned, in the NR sidelink communications, transmission power of a reference signal may vary slot-by-slot due to transmission power control of the transmitting terminal device. In addition, in case the receiving terminal device uses individual measurement reports for reporting the received power of a plurality of reference signals, these measurement reports may not have a same order in time domain as the order in time domain in which the reference signals are transmitted. Moreover, the receiving terminal device may miss some of plurality of reference signals transmitted by the transmitting terminal device.

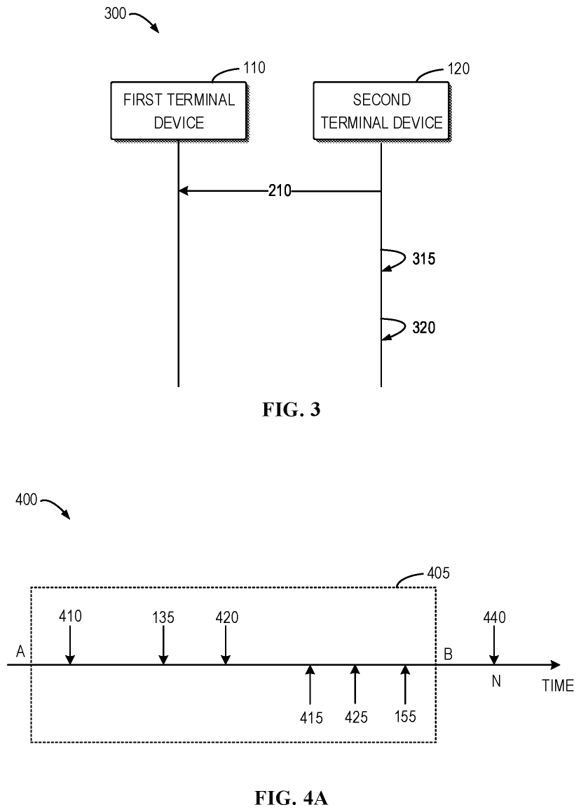

Due to these reasons, in traditional solutions, when a transmitting terminal device of a plurality of reference signals receives a measurement report from a receiving terminal device of the plurality of reference signals, the transmitting terminal device may not know the transmission power of the reference signal with which the measurement report is associated. Thus, the transmitting terminal device may be unable to determine the path loss of the sidelink channel. Some embodiments of the present disclosure provide an approach to solve this issue. This approach can be referred to as an average approach within a time window, which will be described in detail below with reference to FIGS. 3, 4A, 4B, 5A, and 5B.

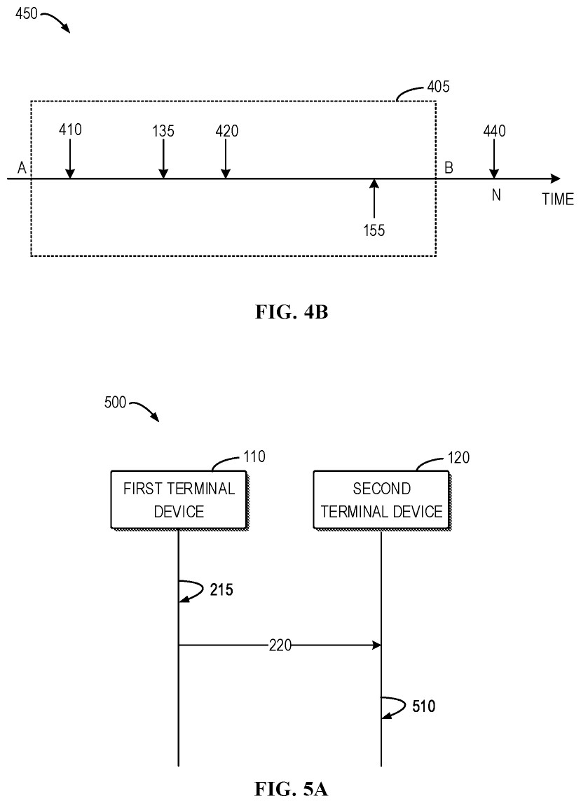

FIG. 3 shows another example communication process 300 between the first terminal device 110 and the second terminal device 120 in accordance with some embodiments of the present disclosure. The communication process 300 may be considered as another embodiment of the communication process 200 as shown in FIG. 2. For the purpose of discussion, the communication process 300 will be described with reference to FIGS. 1, 4A and 4B. However, it would be appreciated that the communication process 300 may be equally applicable to other communication scenarios where two terminal devices communicate with each other via a sidelink channel.

FIG. 4A shows an example scenario in which the first terminal device 110 transmits individual measurement reports for a plurality of reference signals to the second terminal device 120 in accordance with some embodiments of the present disclosure. FIG. 4B shows an example scenario in which the first terminal device 110 transmits a single measurement report for reporting average received power of a plurality of reference signals to the second terminal device 120 in accordance with some embodiments of the present disclosure.

As shown in FIGS. 3 and 4A, the second terminal device 120 transmits 210, in a time window 405, a plurality of reference signals 410, 135, and 420 to the first terminal device 110 via the sidelink channel 125. In the example scenario of FIG. 4A, the time window 405 may be defined at the second terminal device 120 as the transmitting device of the plurality of reference signals 410, 135, and 420. The length and the position of the time window 405 in time domain may be configurable, for example, by a higher layer. It is to be understood that the number of the reference signals and the number of the measurement reports as shown in FIGS. 4A and 4B are only for the purpose of illustration without suggesting any limitations. In other embodiments, the time window 405 may include any suitable number of reference signals and any suitable number of measurement reports.

In some embodiments, if the plurality of reference signals 410, 135, and 420 are associated with a data transmission 440 in the sidelink channel 125, the time window 405 can be defined relative to the time point of the data transmission 440. For example, if the data transmission 440 is performed in a time slot with a sequence number (or an index) of N, then a start point A of the time window 405 may be defined as the time slot with a sequence number of (N−a), and an end point B of the time window 405 may be defined as the time slot with a sequence number of (N−b), where “N,” “a,” and “b” may be integers and their values can be configured by a higher layer.

After transmitting the plurality of reference signals 410, 135, and 420 to the first terminal device 110, the second terminal device 120 determines 315 the average received power of the plurality of reference signals 410, 135, and 420 measured by the first terminal device 110 in the time window 405. There are various manners for the second terminal device 120 to determine 315 the average received power. As a first option, the first terminal device 110 may report the received power of each of the reference signals 410, 135, and 420 to the second terminal device 120, and the average received power can be calculated by the second terminal device 120. In this way, the complexity of the first terminal device 110 can be reduced. Alternatively, as a second option, the first terminal device 110 can calculate the average received power and report it to the second terminal device 120. As such, the number of the measurement reports that need to be transmitted from the first terminal device 110 to the second terminal device 120 can be decreased.

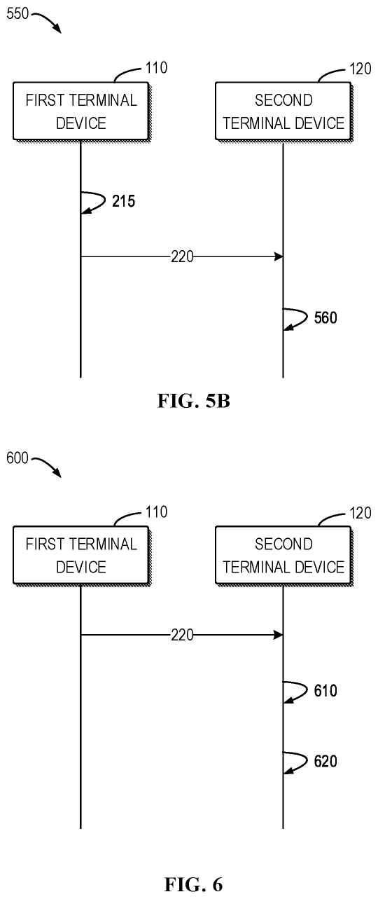

Therefore, the specific manner in which the second terminal device 120 determines 315 the average received power may depend on how the first terminal device 110 reports the measurement results of the plurality of reference signals 410, 135, and 420 to the second terminal device 120. In the following, the first option will be detailed with reference to FIGS. 4A and 5A, and the second option will be detailed with reference to FIGS. 4B and 5B.

FIG. 5A shows another example communication process 500 between the first terminal device 110 and the second terminal device 120 in accordance with some embodiments of the present disclosure. The communication process 500 may be considered as an embodiment of the communication process 300 as shown in FIG. 3. For the purpose of discussion, the communication process 500 will be described with reference to FIGS. 1 and 4A. However, it would be appreciated that the communication process 500 may be equally applicable to other communication scenarios where two terminal devices communicate with each other via a sidelink channel.

As shown in FIGS. 4A and 5A, in the first option, the first terminal device 110 can generate 215 individual measurement reports for the plurality of reference signals 410, 135, and 420, and then transmit 220 them to the second terminal device 120. In other words, for each of the plurality of reference signals 410, 135, and 420, the first terminal device 110 may generate 215 a measurement report to include information indicating the received power of the reference signal. For example, the first terminal device 110 may generate 215 a measurement report 415 for reporting the received power of the reference signal 410, the measurement report 155 for reporting the received power of the reference signal 135, and a measurement report 425 for reporting the received power of the reference signal 420. Then, the first terminal device 110 transmits 220 the measurement reports 415, 155, and 425 to the second terminal device 120.

It can be seen that in the example shown in FIG. 4A, the measurement reports 415, 425, and 155 do not have a same order in time domain as the order in time domain in which the reference signals 410, 135, and 420 are transmitted. However, the embodiments of the present disclosure may be equally applicable to other scenarios where the measurement reports have a same order as the reference signals in time domain, or other scenarios where one or more of the reference signals are not measured by the receiving device, for example, the first terminal device 110 may fail to measure the reference signal 420 and only transmit the measurement reports 415 and 155 without transmitting the measurement report 425.

In case the first terminal device 110 transmits 220 individual measurement reports 415, 425, and 155, the second terminal device 120 may accordingly receive 220 the plurality of measurement reports 415, 425, and 155 from the first terminal device 110 in the time window 405. As described, the first terminal device 110 uses the plurality of measurement reports 415, 425, and 155 for reporting a plurality of received power magnitudes of the plurality of reference signals 410, 135, and 420, respectively. Therefore, the second terminal device 120 can obtain 510 the average received power by averaging the plurality of received power magnitudes reported by the first terminal device 110.

As described above, the first terminal device 110 may use various resources to transmit the plurality of measurement reports 410, 135, and 420. In some embodiments, the first terminal device 110 may transmit the plurality of measurement reports 410, 135, and 420 in a predefined set of transmission resources for a PSSCH from the first terminal device 110 to the second terminal device 120. For example, the plurality of measurement reports 410, 135, and 420 may be multiplexed in predefined PSSCH resources. Alternatively or additionally, the first terminal device 110 may transmit the plurality of measurement reports 410, 135, and 420 in a selected set of transmission resources for the PSSCH, and the selected set can be indicated in an indication transmitted from the first terminal device 110 to the second terminal device 120. For example, the plurality of measurement reports 410, 135, and 420 can be transmitted in resources allocated similar as PSSCH with an indication in SCI indicating that a measurement report exists.

Alternatively or additionally, the first terminal device 110 may transmit the plurality of measurement reports 410, 135, and 420 in a MAC CE from the first terminal device 110 to the second terminal device 120. For example, a field in the MAC CE can be used to indicate the RSRP value to be reported. Alternatively or additionally, the first terminal device 110 may transmit the plurality of measurement reports 410, 135, and 420 in a set of transmission resources for a PSFCH from the first terminal device 110 to the second terminal device 120. Accordingly, depending on the transmission channels or messages in which the plurality of measurement reports 410, 135, and 420 are transmitted 220, the second terminal device 120 may receive 220 the plurality of measurement reports 415, 425, and 155 in one of these transmission channels or messages.

FIG. 5B shows another example communication process 550 between the first terminal device 110 and the second terminal device 120 in accordance with some embodiments of the present disclosure. The communication process 550 may be considered as another embodiment of the communication process 300 as shown in FIG. 3. For the purpose of discussion, the communication process 550 will be described with reference to FIG. 4B. However, it would be appreciated that the communication process 550 may be equally applicable to other communication scenarios where two terminal devices communicate with each other via a sidelink channel.

As shown in FIG. 4B, different from the scenario of FIG. 4A, the time window 405 may be defined at both the first terminal device 110 and the second terminal device 120, and a signal measurement report 155 for the plurality of reference signals 410, 135, and 420 is generated and transmitted to the second terminal device 120. Referring to FIG. 5B, in generating 215 the measurement report 155, the first terminal device 110 may determine the time window 405 for generating the measurement report 155. Then, the first terminal device 110 may obtain average received power of the plurality of reference signals 410, 135, and 420 measured by the first terminal device 110 in the time window 405. Upon obtaining the average received power, the first terminal device 110 may generate the measurement report 155 to include information indicating the average received power.

Afterwards, the first terminal device 110 transmits 220 the measurement report 155 to the second terminal device 120. Accordingly, in determining 315 the average received power of the plurality of reference signals 410, 135, and 420, the second terminal device 120 receives 220 the measurement report 155 from the first terminal device 110 in the time window 405 (for example, at or before the end point B), and then obtains 560 the average received power of the reference signals 410, 135, and 420 from the measurement report 155.

Similar to the embodiment described with reference to FIGS. 4A and 5A, the first terminal device 110 may use various resources to transmit the measurement report 135. For example, the first terminal device 110 may transmit the measurement report 135 in a predefined set of transmission resources for a PSSCH from the first terminal device 110 to the second terminal device 120. Alternatively or additionally, the first terminal device 110 may transmit the measurement report 135 in a selected set of transmission resources for the PSSCH, and the selected set can be indicated in an indication transmitted from the first terminal device 110 to the second terminal device 120. For example, the measurement report 135 can be transmitted in resources allocated similar as PSSCH with an indication in SCI indicating that a measurement report exists.

Alternatively or additionally, the first terminal device 110 may transmit the measurement report 135 in a MAC CE from the first terminal device 110 to the second terminal device 120. For example, a field in the MAC CE can be used to indicate the RSRP value to be reported. Alternatively or additionally, the first terminal device 110 may transmit the measurement report 135 in a set of transmission resources for a PSFCH from the first terminal device 110 to the second terminal device 120. Accordingly, depending on the transmission channels or messages in which the measurement report 135 is transmitted 220, the second terminal device 120 may receive 220 the measurement report 135 in one of these transmission channels or messages.

Referring back to FIG. 3, after determining 315 the average received power of the plurality of reference signals 410, 135, and 420, the second terminal device 120 determines 320 the path loss of the sidelink channel 125 based on a difference between the average received power and average transmission power of the plurality of reference signals 410, 135, and 420. In some embodiments, it is noted that the average transmission power and the average received power are already average values associated with a plurality of reference signals or measurement results within the time window 405. Thus, as a simple option, the second terminal device 120 can directly determine the difference between the average received power and the average transmission power as the path loss. Alternatively, in a more accurate manner, the second terminal device 120 may perform layer 3 filtering on the difference to obtain the path loss. For example, the layer 3 filtering can be performed according to the formula (1) as specified in 3GPP specifications.

As indicated, in traditional solutions and due to various reasons, when a transmitting terminal device of a plurality of reference signals receives a measurement report from a receiving terminal device of the plurality of reference signals, the transmitting terminal device may not know the reference signal with which the measurement report is associated. Some embodiments of the present disclosure solve this technical problem. With these embodiments of the present disclosure, when a transmitting terminal device of a plurality of reference signals receives a measurement report, the transmitting terminal device can determine the reference signal to which the measurement report relates, based on an implicit or explicit mapping between the measurement report and the reference signal. These embodiments of the present disclosure will be detailed below with reference to FIGS. 6-9.

FIG. 6 shows another example communication process 600 between the first terminal device 110 and the second terminal device 120 in accordance with some embodiments of the present disclosure. The communication process 600 may be considered as another embodiment of the communication process 200 as shown in FIG. 2. For the purpose of discussion, the communication process 600 will be described with reference to FIG. 1. However, it would be appreciated that the communication process 600 may be equally applicable to other communication scenarios where two terminal devices communicate with each other via a sidelink channel.

As shown in FIG. 6, the first terminal device 110 transmits 220 the measurement report 155 for reporting the received power of the reference signal 135 measured by the first terminal device 110. In some embodiments, in order to enable the second terminal device 120 to know that the measurement report 155 is for the reference signal 135 upon receiving the measurement report 155, the association between the measurement report 155 and the reference signal 135 can be implicitly indicated through the transmission manner of the measurement report 155. Accordingly, from a perspective of the receiving device of the measurement report 155, the second terminal device 120 receives 220 the measurement report 155 from the first terminal device 110. Then, the second terminal device 120 can determine that the measurement report 155 is associated with the reference signal 135 based on how the measurement report 155 is transmitted, namely, how the measurement report 155 is received.

As an example of such an implicit indication, the first terminal device 110 can use the corresponding relations among a reference signal, a PSSCH, and a PSFCH to implicitly indicate the association between the reference signal and its measurement report. In particular, there may be a one-to-one mapping between a PSSCH and its associated PSFCH in the sidelink communications. Thus, if the reference signal 135 is associated with a PSSCH from the second terminal device 120 to the first terminal device 110, then the first terminal device 110 may transmit the measurement report 155 in a PSFCH from the first terminal device 110 to the second terminal device 120 associated with the PSSCH.

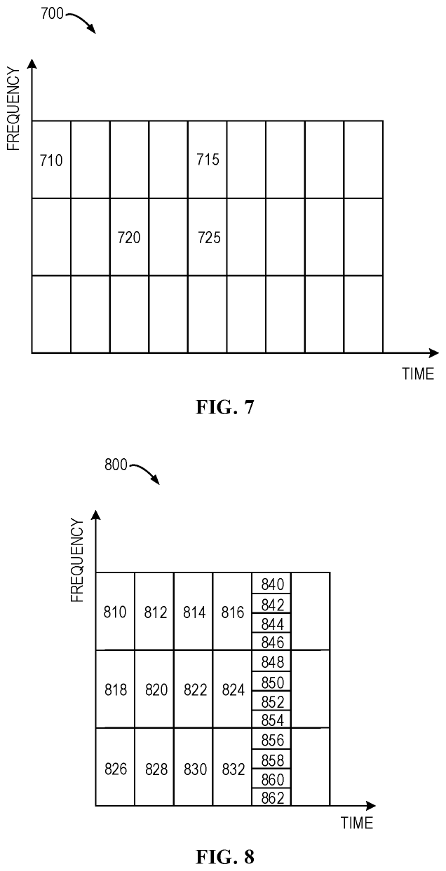

That is, the relation between the measurement report 155 and the reference signal 135 is implicitly indicated through the relation between the PSSCH and its associated PSFCH. Accordingly, the second terminal device 120 as the receiving device of the measurement report 155 may determine that the measurement report 155 is for the reference signal 135, based on the association between the PSSCH of the reference signal 135 and the PSFCH in which the measurement report 155 is transmitted. This kind of implicit indication will be detailed below with reference to FIG. 7.

FIG. 7 shows an example distribution of resources for transmitting reference signals and associated measurement reports in which a measurement report is transmitted in a PSFCH associated with the PSSCH related to the reference signal in accordance with some embodiments of the present disclosure. In FIG. 7, the horizontal axis represents time domain, the vertical axis represents frequency domain, and each block represents a time-frequency resource, for example, a resource of a time slot and a sub-channel.

As shown, the second terminal device 120 may transmit a first reference signal (for example, the reference signal 135) in a first PSSCH resource 710 and a second reference signal in a second PSSCH resource 720. It is assumed that the first PSSCH resource 710 is associated with a first PSFCH resource 715, and the second PSSCH resource 720 is associated with a second PSFCH resource 725. Therefore, the first terminal device 110 can transmit a first measurement report (for example, the measurement report 155) for the first reference signal in the first PSFCH resource 715, and transmit a second measurement report for the second reference signal in the second PSFCH resource 725. In this way, upon receiving the first measurement report in the first PSFCH resource 715, the second terminal device 120 can determine that the first measurement report is for the first reference signal transmitted in the first PSSCH resource 710. Similarly, upon receiving the second measurement report in the second PSFCH resource 725, the second terminal device 120 can determine that the second measurement report is for the second reference signal transmitted in the second PSSCH resource 720.

In some embodiments, for transmitting the measurement report 155 in a PSFCH, the first terminal device 110 can perform a cyclic shift on a sequence of bits to be transmitted in the PSFCH based on a value to be reported in the measurement report 155, so as to obtain the shifted sequence of bits. Then, the first terminal device 110 may transmit the shifted sequence of bits in the PSFCH to the second terminal device 120. Accordingly, the second terminal device 120 can decode the PSFCH to obtain the shifted sequence of bits, and then determine the value to be reported in the measurement report 155, based on the shifted sequence of bits. In this way, there is no need to add more information bits to be transmitted via the PSFCH for representing the value to be reported in the measurement report 155.

As another example of the implicit indication, the second terminal device 120 and the first terminal device 110 can use two corresponding ordered sets of time-frequency resources to transmit reference signals and measurement reports, respectively. In particular, the first ordered set and the second ordered set may have equal number of time-frequency resources, and individual time-frequency resources in the first ordered set may be associated with individual time-frequency resources in the second ordered set, respectively. Therefore, the time-frequency resources in the first ordered set and the time-frequency resources in the second ordered set may have one-to-one mappings. This kind of implicit indication will be detailed below with reference to FIG. 8.

FIG. 8 shows another example distribution of resources for transmitting reference signals and associated measurement reports in which two ordered sets of time-frequency resources are used for transmitting the reference signals and the associated measurement reports, respectively, in accordance with some embodiments of the present disclosure. In FIG. 8, the horizontal axis represents time domain, the vertical axis represents frequency domain, and each block represents a time-frequency resource.

As shown in FIG. 8, the first ordered set of time-frequency resources may include a resource 810, a resource 812, a resource 814, a resource 816, a resource 818, a resource 820, a resource 822, a resource 824, a resource 826, a resource 828, a resource 830, and a resource 832. The second ordered set of time-frequency resources may include a resource 840, a resource 842, a resource 844, a resource 846, a resource 848, a resource 850, a resource 852, a resource 854, a resource 856, a resource 858, a resource 860, and a resource 862.

It is to be understood that the number of the resources in the first ordered set and the number of the resources in the second ordered set as shown in FIG. 8 are only for the purpose of illustration without suggesting any limitations. In other embodiments, the first ordered set may include any suitable number of time-frequency resources, and the second ordered set may include any suitable number of time-frequency resources. In addition, although the size of each of the time-frequency resources in the second ordered set are depicted to be a fraction of the size of each of the time-frequency resources in the first ordered set, the size of an individual resource in the first ordered set may have any suitable relation to the size of an individual resource in the second ordered set. Further, the position relation between the first ordered set and the second ordered set can be any suitable position relation, and is not limited to the position relation as depicted.

In the example of FIG. 8, the resource 810 corresponds to the resource 840, the resource 812 corresponds to the resource 842, the resource 814 corresponds to the resource 844, the resource 816 corresponds to the resource 846, the resource 818 corresponds to the resource 848, the resource 820 corresponds to the resource 850, the resource 822 corresponds to the resource 852, the resource 824 corresponds to the resource 854, the resource 826 corresponds to the resource 856, the resource 828 corresponds to the resource 858, the resource 830 corresponds to the resource 860, and the resource 832 corresponds to the resource 862.

In this event, in transmitting 220 the measurement report 155, if the first terminal device 110 determines that the reference signal 135 is transmitted in a first time-frequency resource (such as, the resource 820) in the first ordered set of time-frequency resources, then the first terminal device 110 can determine a sequence number of the first time-frequency resource in the first ordered set, such as, the sixth. Then, the first terminal device 110 may select, based on the sequence number (such as, the sixth), a second time-frequency resource (such as, the resource 850) from the second ordered set of time-frequency resources. Afterwards, first terminal device 110 can transmit the measurement report 155 in the second time-frequency resource 850.

In the example of FIG. 8, it is assumed that the first and second ordered sets from a resource pool. The measurement reports are configured to be transmitted in the end slot of every N slots, and N equals to 5 in this example. However, the measurement reports may also be configured to be transmitted in other slot, such as, the beginning slot. In the example of FIG. 8, the mapping rule for the order of the first ordered set is that the time domain is firstly considered and the frequency domain is secondly considered. However, this order may be reversed in other embodiments. That is, the frequency domain is firstly considered and the time domain is secondly considered. More generally, the resources in the first ordered set may have any order.

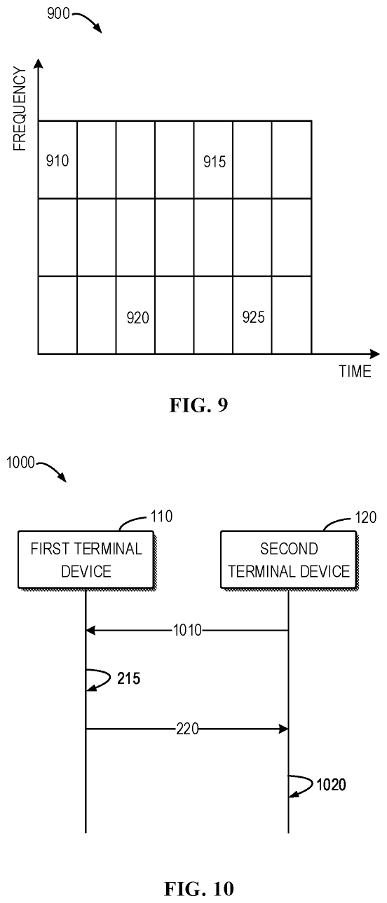

As an alternative to the implicit indication as described above, the first terminal device 110 can explicitly indicate the association between the measurement report 155 and the reference signal 135 in the measurement report 155. For example, the first terminal device 110 may inform the second terminal device 120 of the time point when the first terminal device 110 measures the reference signal 135 through the measurement report 155, so that the second terminal device 120 when receiving the measurement report 155 can be aware that the measurement report 155 is for the reference signal 135 which is transmitted at the indicated time point. This kind of explicit indication will be detailed below with reference to FIG. 9.

FIG. 9 shows another example distribution of resources for transmitting reference signals and associated measurement reports in which a measurement report includes time information of the related reference signal in accordance with some embodiments of the present disclosure. In FIG. 9, the horizontal axis represents time domain, the vertical axis represents frequency domain, and each block represents a time-frequency resource. As shown in FIG. 9, the second terminal device 120 transmits a first reference signal (for example, the reference signal 135) in a resource 910 and a second reference signal in a resource 920. The first terminal device 110 transmits a first measurement report (for example, the measurement report 155) for the first reference signal in a resource 915, and a second measurement report for the second reference signal in a resource 925. In some embodiments, the resource pool for the first device 110 and the resource pool for the second device 120 may be different.

In this event, in generating 215 the measurement report 155, the first terminal device 110 may determine a time point when the first terminal device 110 measures the reference signal 135, for example, the time point of the resource 910. Then, the first terminal device 110 may generate 215 the measurement report 155 to include information indicating the time point of the resource 910. In a similar manner, the first terminal device 110 may generate the second measurement report to include information indicating the time point of the resource 920. In some embodiments, the information may include an index of the time slot of the resource 910. For example, the index of the time slot may range from 0 to 10239.

Instead of indicating the time point of the reference signal 135, in generating 215 the measurement report 155, the first terminal device 110 may determine a first time point (for example, the time point of the resource 910) when the first terminal device 110 measures the reference signal 135. Also, the first terminal device 110 may determine a second time point (for example, the time point of the resource 915) when the first terminal device 110 is to transmit the measurement report. Then, the first terminal device 110 may generate the measurement report 155 to include information indicating a time difference between the first time point and the second time point.

In a similar manner, the first terminal device 110 may generate the second measurement report to include information indicating the time difference between the first time point of the resource 920 and the second time point of the resource 925. In some embodiments, the time difference may be represented by the slot offset between the slot where the reference signal 135 is transmitted and the slot in which the measurement report is transmitted. Alternatively, the time difference may be represented by an absolute time offset (in millisecond or second) between the time point when the measurement report 155 is transmitted and the time point when the reference signal 135 is transmitted.

In some embodiments, if the measurement report 155 is transmitted in a MAC CE, a field in the MAC CE may indicate the time information of the associated reference signal. For example, the time information may be the slot index of the resource for transmitting the reference signal 135, or may be a slot offset between the slot where the reference signal 135 is transmitted and the slot in which the measurement report is transmitted. In addition, a field in the MAC CE can indicate the value to be reported in the measurement report 155.

Referring back to FIG. 6, after receiving 220 the measurement report 155 from the first terminal device 110, the second terminal device 120 determines 610 the transmission power of the reference signal 135. The manner in which the second terminal device 120 determines 610 the transmission power may depend on how the first terminal device 110 transmits the measurement report 155 (for the case of an implicit indication) or the content of the measurement report 155 (for the case of an explicit indication).

For example, in the embodiments as described with reference to FIG. 7, if the second terminal device 120 receives the measurement report 155 in a PSFCH (which is transmitted in the resource 715 in FIG. 7, for example), then the second terminal device 120 may determine a PSSCH (which is transmitted in the resource 710 in FIG. 7, for example) associated with the PSFCH. Afterwards, the second terminal device 120 may determine the transmission power of the reference signal 135 associated with the PSSCH, because the reference signal 135 is transmitted in the resource 710, for example.

In the embodiments as described with reference to FIG. 8, if the second terminal device 120 receives the measurement report 155 in a second time-frequency resource (such as, the resource 850) in the second ordered set of time-frequency resources, then the second terminal device 120 may determine the sequence number (such as, the sixth) of the second time-frequency resource in the second ordered set. Then, the second terminal device 120 can determine, based on the sequence number (such as, the sixth), a first time-frequency resource (such as, the resource 820) in the first ordered set of time-frequency resources. Afterwards, the second terminal device 120 may determine the transmission power of the reference signal 135, because it is transmitted in the first time-frequency resource, such as, the resource 820.

In the embodiments as described with reference to FIG. 9, the second terminal device 120 may determine, in the measurement report 155, a first time point (such as, the slot number of the resource 910) when the second terminal device 120 transmits the reference signal 135. Then, the second terminal device 120 can obtain the transmission power of the reference signal 135 transmitted at the first time point, such as, the slot number of the resource 910.

Alternatively, the second terminal device 120 may determine a second time point (such as, the slot number of the resource 915) when the second terminal device 120 receives the measurement report 135. Then, the second terminal device 120 may determine, in the measurement report 155, a time difference (such as, 4) between a first time point (such as, the slot number of the resource 910) and the second time point (such as, the slot number of the resource 915). Then, the second terminal device 120 may determine the first time point (such as, the slot number of the resource 910) based on the second time point (such as, the slot number of the resource 915) and the time difference (such as, 4). Afterwards, the second terminal device 120 can obtain the transmission power of the reference signal 135 transmitted at the first time point, such as the slot number of the resource 910.

Referring back to FIG. 6, the second terminal device 120 determines 620 the path loss of the sidelink channel 125 based on the received power of the reference signal 135 reported in the measurement report 155 and the transmission power of the reference signal 135 as determined. In some embodiments, the second terminal device 120 may determine a difference between the received power and the transmission power, and then perform the layer 3 filtering on the difference to obtain the path loss. For example, the layer 3 filtering may be performed according to the formula (1) as specified in 3GPP specifications.

Alternatively, the second terminal device 120 may first determine previous transmission power of a previous reference signal transmitted from the second terminal device 120 to the first terminal device 110. Then, the second terminal device 120 may adjust the received power using the transmission power and the previous transmission power to obtain the adjusted received power. In general, the second terminal device 120 can use any suitable adjusting approach to adjust the received power. For example, the adjustment of the received power may be based on the following equation (2).

$$RSRP\_adjusted = RSRP ( i ) + \frac{1 - α}{α} ( {EPRE}_{i} - {EPRE}_{i - 1} ) \qquad ( 2 )$$

where RSRP_adjusted represents the adjusted received power of the reference signal 135, RSRP(i) represents the measured received power of the reference signal 135, EPREᵢ represents the transmission power of the reference signal 135, EPREᵢ₋₁ represents the previous transmission power of the previous reference signal, and α represents a configurable value greater than 0 and less than 1, for example, ½^{(k/4)}.

After adjusting the received power, the second terminal device 120 may perform the layer 3 filtering on the adjusted received power to obtain the filtered received power. For example, this operation may be expressed by the following equation (3):

$$RSRP\_filtered ( i ) = ( 1 - α ) RSRP ( i - 1 ) + α [ RSRP ( i ) + \frac{1 - α}{α} ( {EPRE}_{i} - {EPRE}_{i - 1} ) ] \qquad ( 3 )$$

where RSRP_fltered(i) represents the filtered received power of the reference signal 135, RSRP(i) represents the measured received power of the reference signal 135, RSRP(i−1) represents the previously filtered received power of the previous reference signal, EPREᵢ represents the transmission power of the reference signal 135, EPREᵢ₋₁ represents the previous transmission power of the previous reference signal, and α represents a configurable value greater than 0 and less than 1, for example, ½^{(k/4)}.

After obtaining the filtered received power, the second terminal device 120 may determine the path loss based on a difference between the transmission power and the filtered received power. For example, the path loss may be expressed by EPREᵢ−RSRP_filtered(i).

As described in the foregoing, before using the received power of the reference signal 135 as measured by the first terminal device 110 to determine the path loss of the sidelink channel 125, the second terminal device 120 may perform the layer 3 filtering on the received power of the reference signal 135 to obtain the filtered received power, which is actually used by the second terminal device 120 to determine the path loss of the sidelink channel 125. In some embodiments, this layer 3 filtering may be performed at the first terminal device 110 as the receiving terminal device of the reference signal 135, instead of being performed at the second terminal device 120 as the transmitting terminal device of the reference signal 135. In this way, the complexity of a transmitting device of a reference signal can be reduced. These embodiments will be detailed below with reference to FIG. 10.

FIG. 10 shows another example communication process 1000 between the first terminal device 110 and the second terminal device 120 in accordance with some embodiments of the present disclosure. The communication process 1000 may be considered as another embodiment of the communication process 200 as shown in FIG. 2. For the purpose of discussion, the communication process 1000 will be described with reference to FIG. 1. However, it would be appreciated that the communication process 1000 may be equally applicable to other communication scenarios where two terminal devices communicate with each other via a sidelink channel.

As shown in FIG. 10, in order that the first terminal device 110 can perform the layer 3 filtering, the second terminal device 120 transmits 1010, to the first terminal device 110, information for the first terminal device 110 to perform the layer 3 filtering on the received power of the reference signal 135 measured by the first terminal device 110. It is understood that the information can be any information that enables the first terminal device 110 to perform the layer 3 filtering, and the content of the information may depend on how the first terminal device 110 performs the layer 3 filtering. For example, the information may include transmission power information of the reference signal 135.

In particular, as an example, the information may include the transmission power of the reference signal 135 and reference transmission power of the reference signal 135 shared between the first terminal device 110 and the second terminal device 120. Accordingly, the first terminal device 110 can perform the layer 3 filtering on the measured received power of the reference signal 135 using the transmission power and the reference transmission power. In some embodiments, the second terminal device 120 may inform the reference transmission power to the first terminal device 110, for example, via higher layer signaling. In some other embodiments, the network device 130 can determine the reference transmission power and notifies both the first terminal device 110 and the second terminal device 120 of the reference transmission power, for example, via higher layer signaling. The information including the reference transmission power can be transmitted via a SCI or higher layer signaling that is used in an occasion for measuring the reference signal 135.

Alternatively, as another example, the information may include the transmission power of the reference signal 135 and previous transmission power of a previous reference signal transmitted from the second terminal device 110 to the first terminal device 120. In this case, the first terminal device 110 can perform the layer 3 filtering on the measured received power of the reference signal 135 using the transmission power and the previous transmission power. The information including the previous transmission power can be transmitted via a physical sidelink control channel (PSCCH)/PSSCH or higher layer signaling that is used in an occasion for measuring the reference signal 135.

After receiving 1010 the information from the second terminal device 120, the first terminal device 110 generates 215 the measurement report 155 to include the filtered received power of the reference signal 135 based on the information. The specific manner in which the first terminal device 110 performs the layer 3 filtering on the received power of the reference signal 135 may rely on the particular content of the information. In some embodiments, the first terminal device 110 may firstly adjust the received power of the reference signal 135 measured by the first terminal device 110 to obtain the adjusted received power. This adjustment of the received power may also be referred to as normalization, and thus the adjusted received power can be also called as the normalized received power.

The adjustment of the received power may be different for different contents of the information received from the second terminal device 120. If the information includes the reference transmission power and the transmission power, the first terminal device 110 may adjust the received power using the transmission power and the reference transmission power. For example, the adjusted received power of the reference signal 135 can be obtained by the following equation (4):

RSRP_adjusted=RSRP_measured+EPRE_reference−EPRE_indicated (4)

where RSRP_adjusted represents the adjusted received power of the reference signal 135, RSRP_measured represents the measured received power of the reference signal 135, EPRE_reference represents the reference transmission power of the reference signal 135, and EPRE_indicated represents the transmission power of the reference signal 135.

It is to be appreciated that the above equation (4) is only an example of adjusting the received power of the reference signal 135 without suggesting any limitation. In some other embodiments, the first terminal device 110 can use any other suitable mathematical operations or non-mathematical manners to perform the adjustment. In addition, as indicated above, the reference transmission power can alternatively be informed to the first terminal device 110 by the network device 130 instead of the second terminal device 120. Regardless of the informant of the reference transmission power, the first terminal device 110 can determine reference transmission power of the reference signal 135 shared between the first terminal device 110 and the second terminal device 120.

Alternatively, if the information received by the first terminal device 110 from the second terminal device 120 includes the transmission power and the previous transmission power, the first terminal device 110 may adjust the received power using the transmission power and the previous transmission power. For example, the adjusted received power of the reference signal 135 can be obtained by the following equation (5):

$$RSRP\_adjusted = RSRP\_measured + \frac{1 - α}{α} [ EPRE\_indicated ( n ) - EPRE\_indicated ( n - 1 ) ] \qquad ( 5 )$$

where RSRP_adjusted represents the adjusted received power of the reference signal 135, RSRP_measured represents the measured received power of the reference signal 135, EPRE_indicated(n) represents the transmission power of the reference signal 135, EPRE_indicated(n−1) represents the previous transmission power of the previous reference signal, and α represents a configurable value greater than 0 and less than 1, for example, ½^{(k/4)}.

After obtaining the adjusted received power of the reference signal 135, the first terminal device 110 may perform layer 3 filtering on the adjusted received power to obtain the filtered received power. The first terminal device 110 may perform the layer 3 filtering in various manners. In some embodiments, the layer 3 filtering can be performed based on the following equation (6):

RSRP(n)=(1−α)×RSRP(n−1)+α×RSRP_adjusted (6)

where RSRP(n) represents the filtered received power of the reference signal 135, RSRP(n−1) represents the filtered received power of previous reference signal, and α represents a configurable value greater than 0 and less than 1, for example, ½^{(k/4)}.

Upon obtaining the filtered received power of the reference signal 135, the first terminal device 110 may generate 215 the measurement report 155 to include information indicating the filtered received power. Then, the first terminal device 110 can transmit to the second terminal device 120 the measurement report 155 including the filtered received power of the reference signal 135. Accordingly, from a perspective of the receiving side, the second terminal device 120 receives 220 the measurement report 155 from the first terminal device 110.

Upon receiving the measurement report 155 indicating the filtered received power, the second terminal device 120 determines 1020 the path loss of the sidelink channel 125 based on the filtered received power of the reference signal 135 and the information transmitted from the second terminal device 120 to the first terminal device 110. For example, if the information includes the reference transmission power and the transmission power, then the second terminal device 120 may determine a difference between the reference transmission power and the filtered received power as the path loss. Alternatively, if the information includes the transmission power and the previous transmission power, then the second terminal device 120 may determine a difference between the transmission power and the filtered received power as the path loss.

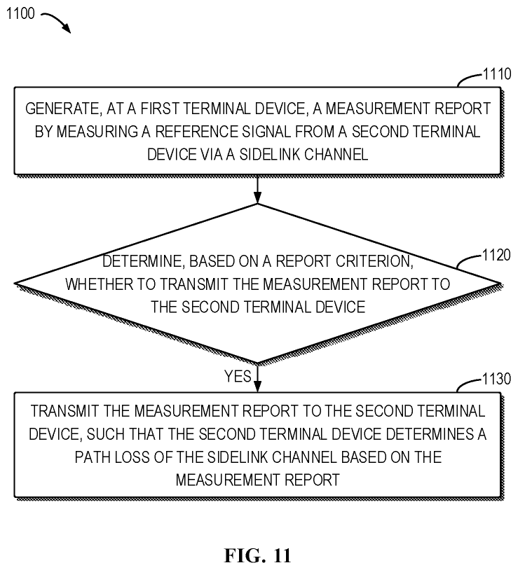

FIG. 11 shows a flowchart of an example method 1100 in accordance with some embodiments of the present disclosure. In some embodiments, the method 1100 can be implemented at a terminal device, such as the first terminal device 110 as shown in FIG. 1. Additionally or alternatively, the method 1100 can also be implemented at the second terminal device 120 or other terminal devices not shown in FIG. 1. For the purpose of discussion, the method 1100 will be described with reference to FIG. 1 as performed by the first terminal device 110 without loss of generality.

At block 1110, the first terminal device 110 generates a measurement report by measuring a reference signal from the second terminal device 120 via a sidelink channel. At block 1120, the first terminal device 110 determines, based on a report criterion, whether to transmit the measurement report to the second terminal device 120. At block 1130, in response to determining that the measurement report is to be transmitted, the first terminal device 110 transmits the measurement report to the second terminal device 120, such that the second terminal device 120 determines a path loss of the sidelink channel based on the measurement report.

In some embodiments, the report criterion comprises at least one of: the second terminal device 120 being to use the path loss of the sidelink channel to perform transmission power control; an estimated path loss of the sidelink channel being below a first threshold; a path loss of a communication channel between the second terminal device 120 and the network device 130 in communication with the second terminal device 120 exceeding a second threshold; and a priority of a sidelink data transmission to be performed via the sidelink channel exceeding a third threshold.

In some embodiments, generating the measurement report comprising: determining, based on a measurement criterion, whether to measure the reference signal; and in response to determining that the reference signal is to be measured, generating the measurement report.

In some embodiments, the measurement criterion comprises at least one of: the second terminal device 120 being to use the path loss of the sidelink channel to perform transmission power control; an estimated path loss of the sidelink channel being below a first threshold; a path loss of a communication channel between the second terminal device 120 and the network device 130 in communication with the second terminal device 120 exceeding a second threshold; and a priority of a sidelink data transmission to be performed via the sidelink channel exceeding a third threshold.

In some embodiments, measuring the reference signal comprises at least one of: measuring received power of the reference signal received via one of a plurality of antenna ports of the first terminal device 110; and measuring average received power of the reference signal received via the plurality of antenna ports of the first terminal device 110.

In some embodiments, measuring the reference signal comprises at least one of: in response to the reference signal being associated with a sidelink data transmission via the sidelink channel, measuring received power of the reference signal; in response to receiving an indication from the second terminal device 120 indicating that the received power of the reference signal is to be measured, measuring the received power of the reference signal; in response to selecting the reference signal from a plurality of reference signals to measure the received power, measuring the received power of the reference signal; and in response to measuring channel state information of the sidelink channel based on the reference signal, measuring the received power of the reference signal.

In some embodiments, generating the measurement report comprises: generating the measurement report to include information indicating received power of the reference signal.

In some embodiments, generating the measurement report comprises: determining a time window for generating the measurement report; obtaining average received power of a plurality of reference signals including the reference signal measured by the first terminal device 110 in the time window; and generating the measurement report to include information indicating the average received power.

In some embodiments, the measurement report is transmitted in at least one of: a predefined set of transmission resources for a PSSCH from the first terminal device 110 to the second terminal device 120; a selected set of transmission resources for the PSSCH, the selected set being indicated in an indication transmitted from the first terminal device 110 to the second terminal device 120; a MAC CE transmitted from the first terminal device 110 to the second terminal device 120; and a set of transmission resources for a PSFCH from the first terminal device 110 to the second terminal device 120.

In some embodiments, transmitting the measurement report comprises: in response to the reference signal being associated with a PSSCH from the second terminal device 120 to the first terminal device 110, transmitting the measurement report in a PSFCH from the first terminal device 110 to the second terminal device 120 associated with the PSSCH.

In some embodiments, transmitting the measurement report in the PSFCH comprises: performing a cyclic shift on a sequence of bits to be transmitted in the PSFCH based on a value to be reported in the measurement report, to obtain the shifted sequence of bits; and transmitting the shifted sequence of bits in the PSFCH to the second terminal device 120.

In some embodiments, transmitting the measurement report comprises: in response to the reference signal being transmitted in a first time-frequency resource in a first ordered set of time-frequency resources, determining a sequence number of the first time-frequency resource in the first ordered set; selecting, based on the sequence number, a second time-frequency resource from a second ordered set of time-frequency resources, individual time-frequency resources in the second ordered set being associated with individual time-frequency resources in the first ordered set, respectively; and transmitting the measurement report in the second time-frequency resource.

In some embodiments, generating the measurement report comprises: determining a first time point when the first terminal device 110 measures the reference signal; and generating the measurement report to include information indicating the first time point.

In some embodiments, generating the measurement report comprises: determining a first time point when the first terminal device 110 measures the reference signal; determining a second time point when the first terminal device 110 is to transmit the measurement report; and generating the measurement report to include information indicating a time difference between the first time point and the second time point.

In some embodiments, generating the measurement report comprises: adjusting received power of the reference signal measured by the first terminal device 110 to obtain the adjusted received power; performing layer 3 filtering on the adjusted received power to obtain the filtered received power; and generating the measurement report to include information indicating the filtered received power.

In some embodiments, adjusting the received power comprises: determining reference transmission power of the reference signal shared between the first terminal device 110 and the second terminal device 120; receiving, from the second terminal device 120, information indicating transmission power of the reference signal; and adjusting the received power using the transmission power and the reference transmission power.

In some embodiments, adjusting the received power comprises: receiving, from the second terminal device 120, information indicating transmission power of the reference signal and previous transmission power of a previous reference signal transmitted from the second terminal device 120 to the first terminal device 110; and adjusting the received power using the transmission power and the previous transmission power.

In some embodiments, the method 1100 further comprises: receiving, from the second terminal device 120, information indicating transmission power of the reference signal; and performing transmission power control based on a difference between the transmission power and received power of the reference signal measured by the first terminal device 110.

In some embodiments, transmitting the measurement report comprises: in response to a difference between a value to be reported in the measurement report and a previous value reported in a previous report exceeding a fourth threshold, transmitting the measurement report; or transmitting a plurality of measurement reports including the measurement report periodically.

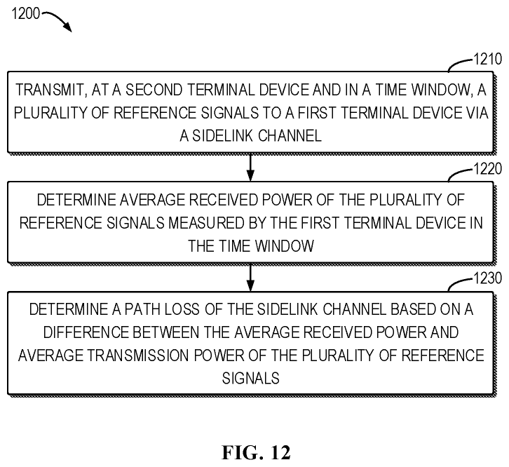

FIG. 12 shows a flowchart of another example method 1200 in accordance with some embodiments of the present disclosure. In some embodiments, the method 1200 can be implemented at a terminal device, such as the second terminal device 120 as shown in FIG. 1. Additionally or alternatively, the method 1200 can also be implemented at the first terminal device 110 or other terminal devices not shown in FIG. 1. For the purpose of discussion, the method 1200 will be described with reference to FIG. 1 as performed by the second terminal device 120 without loss of generality.

At block 1210, the second terminal device 120 transmits in a time window a plurality of reference signals to a first terminal device 110 via a sidelink channel. At block 1220, the second terminal device 120 determines average received power of the plurality of reference signals measured by the first terminal device 110 in the time window. At block 1230, the second terminal device 120 determines a path loss of the sidelink channel based on a difference between the average received power and average transmission power of the plurality of reference signals.

In some embodiments, determining the average received power comprises: receiving a plurality of measurement reports from the first terminal device 110 in the time window, the plurality of measurement reports being used for reporting a plurality of received power magnitudes of the plurality of reference signals, respectively; and obtaining the average received power by averaging the plurality of received power magnitudes.

In some embodiments, the plurality of measurement reports are received in at least one of: a predefined set of transmission resources for a PSSCH from the first terminal device 110 to the second terminal device 120; a selected set of transmission resources for the PSSCH, the selected set being indicated in an indication transmitted from the first terminal device 110 to the second terminal device 120; a MAC CE transmitted from the first terminal device 110 to the second terminal device 120; and a set of transmission resources for a PSFCH from the first terminal device 110 to the second terminal device 120.

In some embodiments, determining the average received power comprises: receiving a measurement report from the first terminal device 110 in the time window, the measurement report being used for reporting the average received power; and obtaining the average received power from the measurement report.

In some embodiments, the measurement report is received in at least one of: a predefined set of transmission resources for a PSSCH from the first terminal device 110 to the second terminal device 120; a selected set of transmission resources for the PSSCH, the selected set being indicated in an indication transmitted from the first terminal device 110 to the second terminal device 120; a MAC CE transmitted from the first terminal device 110 to the second terminal device 120; and a set of transmission resources for a PSFCH from the first terminal device 110 to the second terminal device 120.

In some embodiments, determining the path loss comprises: determining the difference between the average received power and the average transmission power as the path loss; or performing layer 3 filtering on the difference to obtain the path loss.

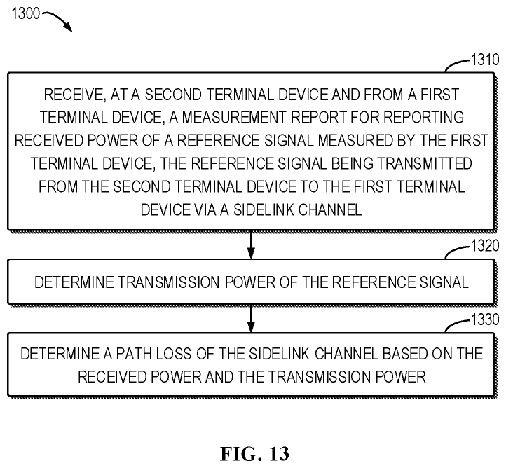

FIG. 13 shows a flowchart of another example method 1300 in accordance with some embodiments of the present disclosure. In some embodiments, the method 1300 can be implemented at a terminal device, such as the second terminal device 120 as shown in FIG. 1. Additionally or alternatively, the method 1300 can also be implemented at the first terminal device 110 or other terminal devices not shown in FIG. 1. For the purpose of discussion, the method 1300 will be described with reference to FIG. 1 as performed by the second terminal device 120 without loss of generality.

At block 1310, the second terminal device 120 receives from the first terminal device 110 a measurement report for reporting received power of a reference signal measured by the first terminal device 110. The reference signal is transmitted from the second terminal device to the first terminal device 110 via a sidelink channel. At block 1320, the second terminal device 120 determines transmission power of the reference signal. At block 1330, the second terminal device 120 determines a path loss of the sidelink channel based on the received power and the transmission power.

In some embodiments, determining the transmission power comprises: in response to receiving the measurement report in a PSFCH determining a PSSCH associated with the PSFCH; and determining the transmission power of the reference signal associated with the PSSCH.

In some embodiments, determining the transmission power comprises: in response to receiving the measurement report in a second time-frequency resource in a second ordered set of time-frequency resources, determining a sequence number of the second time-frequency resource in the second ordered set; determining, based on the sequence number, a first time-frequency resource in a first ordered set of time-frequency resources, individual time-frequency resources in the first ordered set being associated with individual time-frequency resources in the second ordered set, respectively; and determining the transmission power of the reference signal transmitted in the first time-frequency resource.

In some embodiments, determining the transmission power comprises: determining, in the measurement report, a first time point when the second terminal device 120 transmits the reference signal; and obtaining the transmission power of the reference signal transmitted at the first time point.

In some embodiments, determining the transmission power comprises: determining a second time point when the second terminal device 120 receives the measurement report; determining, in the measurement report, a time difference between a first time point and the second time point; determining the first time point based on the second time point and the time difference; and obtaining the transmission power of the reference signal transmitted at the first time point.

In some embodiments, determining the path loss comprises: determining a difference between the received power and the transmission power; and performing layer 3 filtering on the difference to obtain the path loss.

In some embodiments, determining the path loss comprises: determining previous transmission power of a previous reference signal transmitted from the second terminal device 120 to the first terminal device 110; adjusting the received power using the transmission power and the previous transmission power to obtain the adjusted received power; performing layer 3 filtering on the adjusted received power to obtain the filtered received power; and determining the path loss based on a difference between the transmission power and the filtered received power.

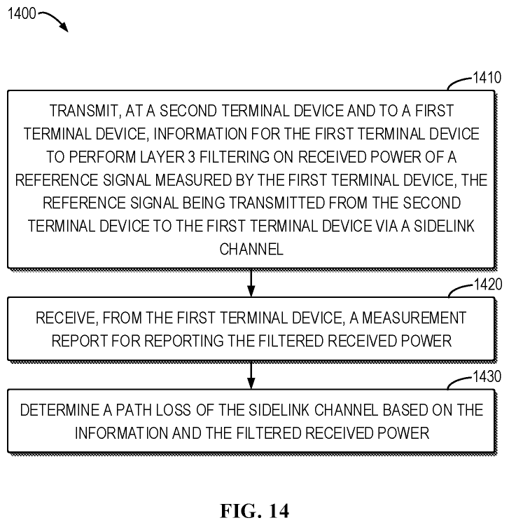

FIG. 14 shows a flowchart of another example method 1400 in accordance with some embodiments of the present disclosure. In some embodiments, the method 1400 can be implemented at a terminal device, such as the second terminal device 120 as shown in FIG. 1. Additionally or alternatively, the method 1400 can also be implemented at the first terminal device 110 or other terminal devices not shown in FIG. 1. For the purpose of discussion, the method 1400 will be described with reference to FIG. 1 as performed by the second terminal device 120 without loss of generality.

At block 1410, the second terminal device 120 transmits to a first terminal device 110 information for the first terminal device 110 to perform layer 3 filtering on received power of a reference signal measured by the first terminal device 110. The reference signal is transmitted from the second terminal device 120 to the first terminal device 110 via a sidelink channel. At block 1420, the second terminal device 120 receives, from the first terminal device 110, a measurement report for reporting the filtered received power. At block 1430, the second terminal device 120 determines a path loss of the sidelink channel based on the information and the filtered received power.

In some embodiments, the information comprises: transmission power of the reference signal; and reference transmission power of the reference signal shared between the first terminal device 110 and the second terminal device 120.

In some embodiments, determining the path loss comprises: determining a difference between the reference transmission power and the filtered received power as the path loss.

In some embodiments, the information comprises: transmission power of the reference signal; and previous transmission power of a previous reference signal transmitted from the second terminal device 120 to the first terminal device 110.

In some embodiments, determining the path loss comprises: determining a difference between the transmission power and the filtered received power as the path loss.

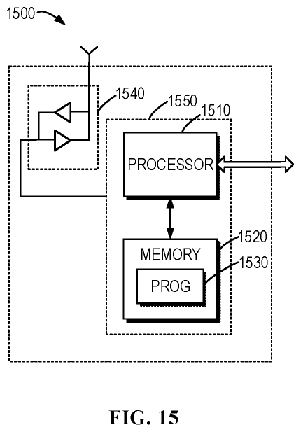

FIG. 15 is a simplified block diagram of a device 1500 that is suitable for implementing some embodiments of the present disclosure. The device 1500 can be considered as a further example embodiment of the first terminal device 110, the second terminal device 120, and the network device 130 as shown in FIG. 1. Accordingly, the device 1500 can be implemented at or as at least a part of the first terminal device 110, the second terminal device 120, and the network device 130.

As shown, the device 1500 includes a processor 1510, a memory 1520 coupled to the processor 1510, a suitable transmitter (TX) and receiver (RX) 1540 coupled to the processor 1510, and a communication interface coupled to the TX/RX 1540. The memory 1520 stores at least a part of a program 1530. The TX/RX 1540 is for bidirectional communications. The TX/RX 1540 has at least one antenna to facilitate communication, though in practice an Access Node mentioned in this application may have several ones. The communication interface may represent any interface that is necessary for communication with other network elements, such as X2 interface for bidirectional communications between gNBs or eNBs, Si interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1530 is assumed to include program instructions that, when executed by the associated processor 1510, enable the device 1500 to operate in accordance with the embodiments of the present disclosure, as discussed herein with reference to FIGS. 11 to 14. The embodiments herein may be implemented by computer software executable by the processor 1510 of the device 1500, or by hardware, or by a combination of software and hardware. The processor 1510 may be configured to implement various embodiments of the present disclosure. Furthermore, a combination of the processor 1510 and memory 1520 may form processing means 1550 adapted to implement various embodiments of the present disclosure.

The memory 1520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1520 is shown in the device 1500, there may be several physically distinct memory modules in the device 1500. The processor 1510 may be of any type suitable to the local technical network, and may include one or more of general purpose computers, special purpose computers, microprocessors, digital signal processors (DSPs) and processors based on multicore processor architecture, as non-limiting examples. The device 1500 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 11 to 14. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method performed by a first terminal device, comprising:
receiving a physical sidelink shared channel (PSSCH) demodulation (DM)-reference signal (RS);
and
transmitting a measurement report for reporting reference signal received power (RSRP) obtained from the PSSCH DM-RS.

2-4. (canceled)

5. The method of claim 1, wherein
the RSRP is average received power associated with PSSCH DM-RSs received via the plurality of antenna ports of the first terminal device.

6-11. (canceled)

12. The method of claim 1, wherein transmitting the measurement report comprises:
in response to the PSSCH DM-RS being transmitted in a first time-frequency resource in a first ordered set of time-frequency resources, determining a sequence number of the first time-frequency resource in the first ordered set;
selecting, based on the sequence number, a second time-frequency resource from a second ordered set of time-frequency resources, individual time-frequency resources in the second ordered set being associated with individual time-frequency resources in the first ordered set, respectively; and
transmitting the measurement report in the second time-frequency resource.

13-14. (canceled)

15. The method of claim 1, further comprising:
generating the measurement report comprising:
adjusting the RSRP measured by the first terminal device to obtain the adjusted received power;
performing layer 3 filtering on the adjusted received power to obtain the filtered received power; and
generating the measurement report to include information indicating the filtered received power.

16. The method of claim 15, wherein adjusting the RSRP comprises:
determining reference transmission power of the PSSCH DM-RS shared between the first terminal device and a second terminal device;
receiving, from the second terminal device, information indicating transmission power of the PSSCH DM-RS; and
adjusting the RSRP using the transmission power and the reference transmission power.

17. The method of claim 15, wherein adjusting the RSRP comprises:
receiving, from the second terminal device, information indicating transmission power of the PSSCH DM-RS and previous transmission power of a previous PSSCH DM-RS transmitted from the second terminal device to the first terminal device; and
adjusting the RSRP using the transmission power and the previous transmission power.

18-25. (canceled)

26. A method performed by a second terminal device, comprising:
transmitting a physical sidelink shared channel (PSSCH) demodulation (DM)-reference signal (RS) to a first terminal device;
receiving a measurement report for reporting reference signal received power (RSRP) obtained from the PSSCH DM-RS from the first terminal device; and
determining a path loss of the sidelink channel based on a difference between the RSRP and the transmission power of the PSSCH DM-RS.

27. (canceled)

28. The method of claim 26, further comprising:
determining the transmission power comprising:
in response to receiving the measurement report in a second time-frequency resource in a second ordered set of time-frequency resources, determining a sequence number of the second time-frequency resource in the second ordered set;
determining, based on the sequence number, a first time-frequency resource in a first ordered set of time-frequency resources, individual time-frequency resources in the first ordered set being associated with individual time-frequency resources in the second ordered set, respectively; and
determining the transmission power of the PSSCH DM-RS transmitted in the first time-frequency resource.

29-30. (canceled)

31. The method of claim 26, wherein determining the path loss comprises:
determining a difference between the RSRP and the transmission power; and
performing layer 3 filtering on the difference to obtain the path loss.

32. The method of claim 26, wherein determining the path loss comprises:
determining previous transmission power of a previous PSSCH DM-RS transmitted from the second terminal device to the first terminal device;
adjusting the RSRP using the transmission power and the previous transmission power to obtain the adjusted RSRP;
performing layer 3 filtering on the adjusted RSRP to obtain the filtered RSRP; and
determining the path loss based on a difference between the transmission power and the filtered RSRP.

33. A method for communication, comprising:
transmitting, at a second terminal device and to a first terminal device, information for the first terminal device to perform layer 3 filtering on received power of a reference signal measured by the first terminal device, the reference signal being transmitted from the second terminal device to the first terminal device via a sidelink channel;
receiving, from the first terminal device, a measurement report for reporting the filtered received power; and
determining a path loss of the sidelink channel based on the information and the filtered received power.

34. The method of claim 33, wherein the information comprises:
transmission power of the reference signal; and
reference transmission power of the reference signal shared between the first terminal device and the second terminal device.

35. The method of claim 34, wherein determining the path loss comprises:
determining a difference between the reference transmission power and the filtered received power as the path loss.

36. The method of claim 33, wherein the information comprises:
transmission power of the reference signal; and
previous transmission power of a previous reference signal transmitted from the second terminal device to the first terminal device.

37. The method of claim 36, wherein determining the path loss comprises:
determining a difference between the transmission power and the filtered received power as the path loss.

38-40. (canceled)

41. The method of claim 1, wherein the RSRP is a higher layer filtered RSRP.

42. The method of claim 41, wherein the higher layer filtered RSRP is filtered based on a configured filter coefficient for the DM-RS.

43. The method of claim 1, wherein transmitting the measurement report comprises:
transmitting the measurement report periodically or based on an event associated with a threshold.

44. The method of claim 26, wherein the RSRP is average received power associated with PSSCH DM-RSs received via a plurality of antenna ports of the first terminal device.

45. The method of claim 26, wherein the RSRP is a higher layer filtered RSRP.

46. The method of claim 45, wherein the higher layer filtered RSRP is filtered based on a configured filter coefficient for the DM-RS.

47. The method of claim 26, wherein receiving the measurement report comprises:
receiving the measurement report periodically or based on an event associated with a threshold.
